(19) United States
(12) Patent Application Publication
(10) Pub. No.: US 2026/0199911 A1
(43) Pub. Date: Jul. 16, 2026

(54) Cyclonic Separator System with a Bypass Conduit

(71) Applicants: Helmi Al-Jamal, Richmond, TX (US); Francois Martin, Cypress, TX (US)

(72) Inventors: Helmi Al-Jamal, Richmond, TX (US); Francois Martin, Cypress, TX (US)

(21) Appl. No.: 19/236,006

(22) Filed: Jun. 12, 2025

Related U.S. Application Data
(60) Provisional application No. 63/744,171, filed on Jan. 10, 2025.

(51) Int. Cl. B04C 5/30; B04C 5/12; B04C 5/14; B04C 5/26

(52) U.S. Cl. CPC B04C 5/30; B04C 5/12; B04C 5/14; B04C 5/26

(57) ABSTRACT

The cyclonic separator system with a bypass conduit described herein includes a primary separator for initial separation of a process stream into a filtered stream and a primary sand stream, and a secondary separator that receives the primary sand stream for further separation and disposal. A bypass conduit conveys a bypass stream from the secondary separator to the primary separator. The bypass conduit has an inlet within the secondary separator and an outlet that can selectively discharge within the primary separator or merge with the incoming process stream. In some embodiments, a splitting valve on the bypass conduit directs the bypass stream based on pressure differentials, mitigating backflow. This configuration aims to improve separation efficiency and operability of the separation system.

### CROSS-REFERENCE TO RELATED APPLICATIONS

This application claims benefit of priority from U.S. Provisional Application Ser. No. 63/744,171, filed Jan. 10, 2025, the entire contents of which are hereby incorporated by reference.

### BACKGROUND

### Field of the Invention

This disclosure relates to cyclonic separators; more particularly, to cyclonic separators with multiple separation stages and at least one bypass conduit between the stages.

### Description of the Related Art

Oil and gas are produced from underground reservoirs after drilling a hole in the ground whether on land or at the bottom of ocean. The produced oil and/or gas contain various constituent materials including sand particles. These sand particles need to be filtered out from the produced stream prior it is sent to further processing or to customers because the presence of sand particles damages downstream equipment if not filtered out. Desanders are commonly used equipment in the Oil and Gas industry to filter out these sand particles using cyclonic separators. These cyclonic separators function by pushing the sand particles to the outside walls of the cyclone because of the relatively high inertia of the sand. Circulation within the cyclonic separator is promoted by inserting the process stream through the inlet at a tangential angle to the inside wall of the cyclonic separator. The sand then falls downward due to gravity, and the filtered stream exits upward through the center of the cyclone because of pressure depression.

The oil and gas industry has struggled to develop desanding technologies that are effective at filtering sand from a process stream consisting of oil and gas over a broad range of production flowrate scenarios. For example, existing cyclonic separators which operate near 100% efficiency at a low production flow rate are unlikely to operate efficiently at a high production flow rates. This inconsistency in efficiency forces the industry to operate multiple versions of desander cyclones depending on the production conditions.

Therefore, developing a desander cyclone that operates well at different flowrates and at different phase fractions of produced oil and gas would simplify the filtering process and reduce time and effort in switching between different cyclones in the production field.

Furthermore, oil and gas facility operators prefer to operate cyclonic separators with a closed disposal port. This is because if the disposal port is left opened, the filtered sand exiting through the disposal port will have unacceptably high levels of oil and/or gas, which is considered a safety hazard. For that reason, operators typically operate cyclonic separators with the disposal port closed, thereby causing the cyclonic separator to operate intermittently.

In addition, empirical experience shows that the sand-collecting drum below the cyclonic separator often develops a high-pressure field that, in many conditions, prevents some sand particles from being deposited down into the sand-collecting drum. This can cause sand particles to be re-mixed into the fluid within the cyclonic separator, ultimately causing the sand to be entrained in the filtered stream which exits the filtered outlet through the top of the cyclonic separator.

Therefore, developing a cyclonic separation which mitigates against a high-pressure environment developing within the sand-collecting drum would be useful because that would improve the performance of the cyclonic separator system.

### SUMMARY

The disclosure concerns a cyclonic separator system with a bypass conduit, also called the “separation system,” herein. The separation system separates constituent materials from a process stream such as oil, gas and other mining process streams. More specifically, the separation system filters gas from a process stream which may contain oil, water, gas, particulate matter, or some combination thereof. The separation system comprises a primary separator, a secondary separator, and a bypass conduit which recirculates a bypass stream from the secondary separator to the primary separator.

The process stream enters the primary separator and induces a rotational flow within the primary separator enclosure. Due to its higher density, the particulate matter, called “sand” herein, tends to collect towards the lateral walls of the primary enclosure, where it falls downwards. Similarly, the medium-density water and oil tend to collect towards the lateral walls of the primary enclosure where they fall downward. The less-dense gas tends to collect towards the center of the enclosure where it flows up and out of the primary separator. The heavier constituents collect towards the lower end of the separator before exiting the primary outlet of the primary separator. The stream which exits the bottom of the primary separator, called the primary sand stream, is conveyed to a secondary separator.

The secondary separator receives the primary sand stream, and the sand collects towards the lower end of the secondary separator. The fluid constituents in the primary sand stream collect within the secondary separator. The secondary separator has a bypass conduit which is configured to convey a bypass stream from the secondary separator to the primary separator. In a first embodiment of the separator system the bypass stream is conveyed directly into the primary separator enclosure. In a second embodiment, the bypass stream is conveyed into the process stream before entering the primary separator enclosure. In a third embodiment, the bypass conduit has an interior bypass branch and an exterior bypass branch which are configured to convey the bypass stream into the primary enclosure or the process stream, depending on the characteristics of the process stream or the desired operating conditions of the separator system.

The bypass conduit may help reduce the developed pressure in the secondary separator. One purpose of the bypass conduit is to create a secondary pathway to push the traces of oil or gas constituents present in the secondary separator back to the filtered outlet utilizing the pressure difference between the secondary separator and the cyclonic core below the filtered outlet. The cyclonic core below the filtered outlet tends to have the lowest pressure within the interior of the primary separator.

In the second and third embodiments, fine sand particles that may be part of the bypass stream, may be added to the process stream and recirculated through the primary separator. One advantage of the first embodiment over the second embodiment may be that the differential pressure across the bypass conduit in the first embodiment may be larger than that in secondary embodiment because the static pressure at the bypass outlet may be lower than that at the bypass inlet.

### BRIEF DESCRIPTION OF THE DRAWINGS

Other features, combinations, and embodiments will be appreciated by one having the ordinary level of skill in the art of cyclonic separation systems and accessories upon a thorough review of the following details and descriptions, particularly when reviewed in conjunction with the drawings, wherein:

FIG. 1A shows a perspective view of the separation system in accordance with a first illustrated embodiment;

FIG. 1B shows a side view of the separation system in accordance with a first illustrated embodiment;

FIG. 1C shows a back view of the separation system in accordance with a first illustrated embodiment;

FIG. 1D shows a side sectional view of the separation system in accordance with a first illustrated embodiment;

FIG. 1E shows a front sectional view of the separation system in accordance with a first illustrated embodiment;

FIG. 2A shows a perspective view of the separation system in accordance with a second illustrated embodiment;

FIG. 2B shows a side view of the separation system in accordance with a second illustrated embodiment;

FIG. 2C shows a back view of the separation system in accordance with a second illustrated embodiment;

FIG. 2D shows a side sectional view of the separation system in accordance with a second illustrated embodiment;

FIG. 2E shows a front sectional view of the separation system in accordance with a second illustrated embodiment;

FIG. 3A shows a perspective view of the separation system in accordance with a third illustrated embodiment;

FIG. 3B shows a side view of the separation system in accordance with a third illustrated embodiment;

FIG. 3C shows a back view of the separation system in accordance with a third illustrated embodiment;

FIG. 3D shows a side sectional view of the separation system in accordance with a third illustrated embodiment; and

FIG. 3E shows a front sectional view of the separation system in accordance with a third illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, reference numbers are provided in the drawings for illustrating certain features of embodiments. Where distinct figures of the drawings utilize a shared reference number, it can be appreciated that the feature corresponding to the shared reference number is the same or similar, perhaps observed from a different view, or observed with respect to a different embodiment deploying the same or similar feature.

Unless explicitly defined herein, terms are to be construed in accordance with the plain and ordinary meaning as would be appreciated by one having skill in the art.

### General Description of Embodiments

The sand separation system with a bypass conduit comprises a primary separator, a secondary separator, and a bypass conduit.

### Primary Separator

In some embodiments, the primary separator comprises a primary enclosure, a primary inlet, a filtered outlet, and a primary outlet. The primary enclosure is the interior surface of the primary separator, and it may be bounded by an upper end, a lower end, and a lateral wall which spans the distance between the upper end and lower end. A process stream enters the primary enclosure through the primary inlet. The primary inlet is an opening through the primary enclosure. In some embodiments, there is a process stream conduit upstream of the primary inlet. In some embodiments, the process stream conduit upstream of the primary inlet is tangentially oriented to the lateral wall of the primary enclosure. The tangential orientation of the process stream conduit induces a rotational circulation within the primary enclosure.

The primary separator has a filtered outlet which is an opening through the primary enclosure. In some embodiments, the filtered outlet is disposed in the center of top of the primary separator. The filtered stream exits the primary enclosure through the filtered outlet. The primary separator has a primary outlet which is an opening through the primary enclosure. In some embodiments, the primary outlet is disposed in the center of the bottom of the primary separator. The primary sand stream exits the primary enclosure through the primary outlet. After exiting the primary outlet, the primary sand stream is conveyed to the secondary separator.

In some embodiments, the separation system may further comprise an isolation shroud. The isolation shroud may be attached to the upper end of the primary enclosure around the filtered outlet. The isolation shroud may have a bottom opening where the filtered stream enters the isolations shroud. In some embodiments, the purpose of the isolation shroud is to partially isolate the bypass stream from the process stream entering the primary enclosure through the primary inlet.

### Secondary Separator

In some embodiments, the secondary separator comprises a secondary enclosure, a secondary inlet, and a disposal port. The secondary enclosure is the interior surface of the secondary separator, and it may be bounded by an upper end, a lower end and a lateral wall which spans the distance between the upper end and the lower end. The primary sand stream enters the secondary enclosure through the secondary inlet. The secondary inlet is an opening through the primary enclosure towards the secondary enclosure. The disposal port is an opening through the secondary enclosure where a disposal stream exits the secondary enclosure. In some embodiments, the disposal port is located in the center of the secondary enclosure towards the lower end.

### Bypass Conduit

The bypass conduit is configured to convey a bypass stream. In some embodiments, the bypass conduit has a bypass inlet and a bypass outlet. The bypass inlet is disposed within the secondary enclosure. In some embodiments, the bypass inlet is disposed within the horizontal center of the secondary enclosure. In some embodiments, the bypass inlet may be oriented upward facing the upper end of the secondary enclosure. An upwardly oriented bypass inlet may assist in directing the traces of oil and gas within the primary sand stream to the bypass outlet. If the bypass outlet is located inside the isolation shroud, the bypass outlet may experience a lower pressure than the bypass inlet, thereby motivating flow from the bypass inlet to the bypass outlet.

In some embodiments, the bypass outlet is disposed within the primary enclosure. In some embodiments, the bypass outlet is disposed within the horizontal center of the primary enclosure. In some embodiments, the bypass outlet merges with the process stream upstream of the primary inlet. In some embodiments, the bypass outlet merges with the process stream conduit at an angle.

The bypass conduit inlet and exit may both be oriented opposite to the deposition direction of sand particles and semi-isolated from the sand in the process stream by an isolation shroud and from deposited sand through the primary sand conduit.

Another benefit of the bypass conduit is that it may lower the pressure inside the secondary separator because of a suction effect generated by the bypass pipe which may help drive sand downwards from the primary separator to the secondary separator.

### Splitting Valve

In some embodiments, the bypass conduit comprises a splitting valve, an interior bypass branch, and an exterior bypass branch. The bypass outlet of the interior bypass branch may be disposed within the primary enclosure. The bypass outlet of the exterior bypass branch may merge with the process stream upstream of the primary inlet. The splitting valve may be disposed on the bypass conduit. The splitting valve may be configured to convey the bypass stream from the bypass inlet through the interior bypass branch when the splitting valve is in a first position. The splitting valve may be configured to convey the bypass stream from the bypass inlet through the exterior bypass branch when the splitting valve is in a second position.

In some embodiments, the splitting valve is configured to assume the first position when the static pressure at the primary inlet is higher than the bypass inlet. This configuration may mitigate against backflow in the bypass conduit. In some embodiments, the splitting valve may be configured to assume the second position when the static pressure at the primary inlet is lower than the static pressure at the bypass inlet.

### Primary Sand Conduit

In some embodiments, the separation system may further comprise a primary sand conduit. The primary sand conduit is configured to receive the primary sand stream from the primary outlet and to convey the primary sand stream into the secondary enclosure. The purpose of the primary sand conduit is to direct the primary sand stream in an efficient manner within the secondary enclosure. The primary sand conduit may comprise a primary sand outlet. In some embodiments, the primary sand outlet is disposed at a level below the bypass inlet. In some embodiments, the primary sand outlet is disposed near the lateral wall of the secondary separator.

The primary sand conduit may comprise a primary sand outlet segment. In some embodiments, the primary sand outlet segment is a straight run of pipe which terminates in the primary sand outlet. In some embodiments the primary sand outlet segment is oriented at an angle between 0-degrees, horizontal, and 90-degrees below horizontal.

### Inventory of Streams

Typically, the process stream entering will be some mixture of oil, gas, water, sand, other fluid constituents or some combination thereof. The filtered stream exiting the primary separator is intended to be primarily gas, however as with most separation technology, the separation process is not 100% efficient. The filtered stream may still contain trace amounts of oil, gas, sand, other fluid constituents or some combination thereof, in addition to gas.

Similarly, the primary sand stream exiting the primary enclosure is intended to be primarily sand, with water, oil, or heavy fluid constituents. However, in practice the primary sand stream may be a mixture of oil, gas, water, sand, other fluid constituents or some combination thereof.

Similarly, the disposal stream is intended to be primarily sand, with water, oil and heavy fluid constituents. However, in practice the disposal stream may be a mixture of oil, gas, water, sand or some combination thereof.

The bypass stream is intended to recirculate gas from the secondary separator back to the primary separator. However, in practice the bypass stream may be a mixture of oil, gas, water, trace amounts of sand, other fluid constituents or some combination thereof.

### Primary Embodiment

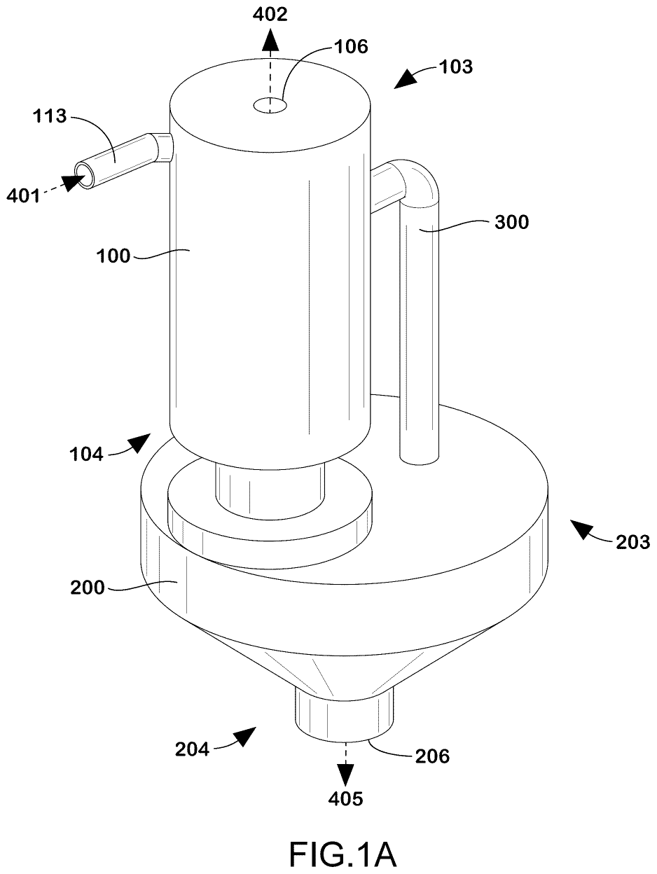

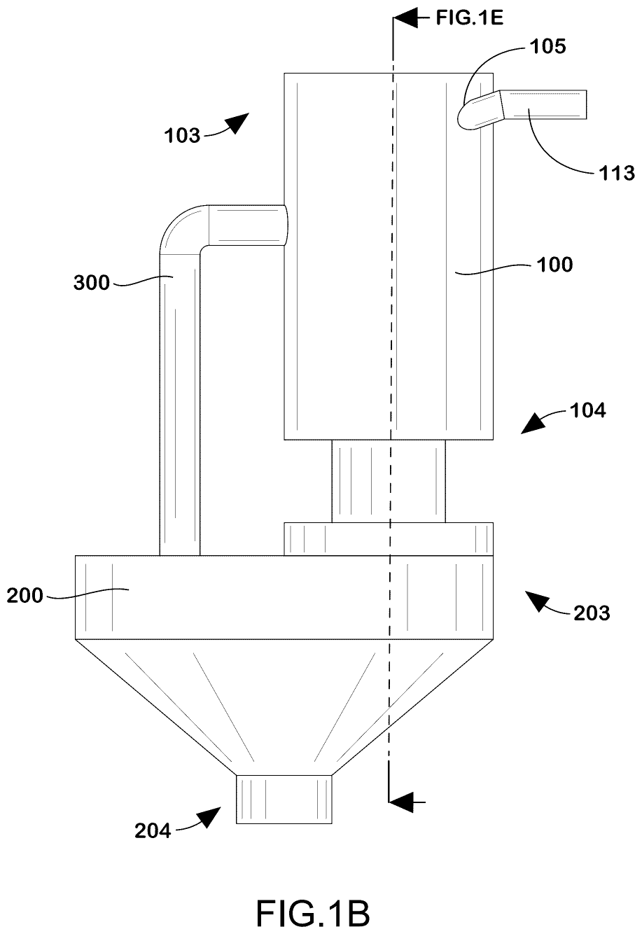

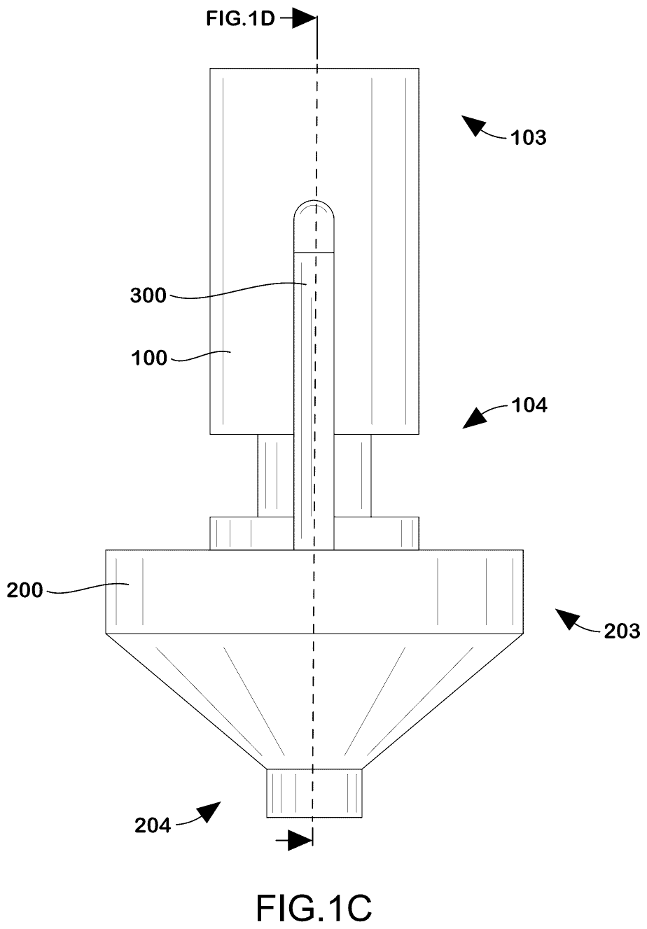

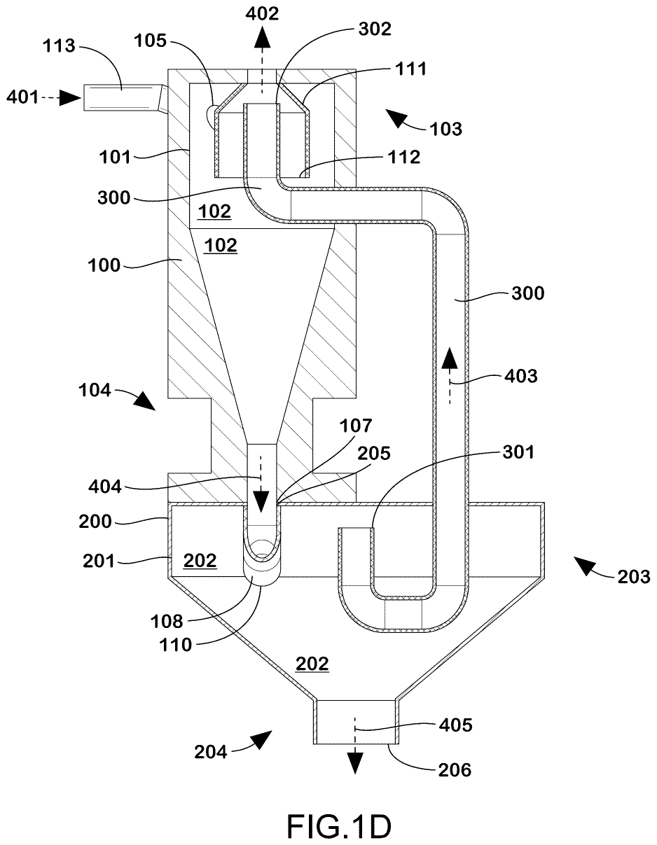

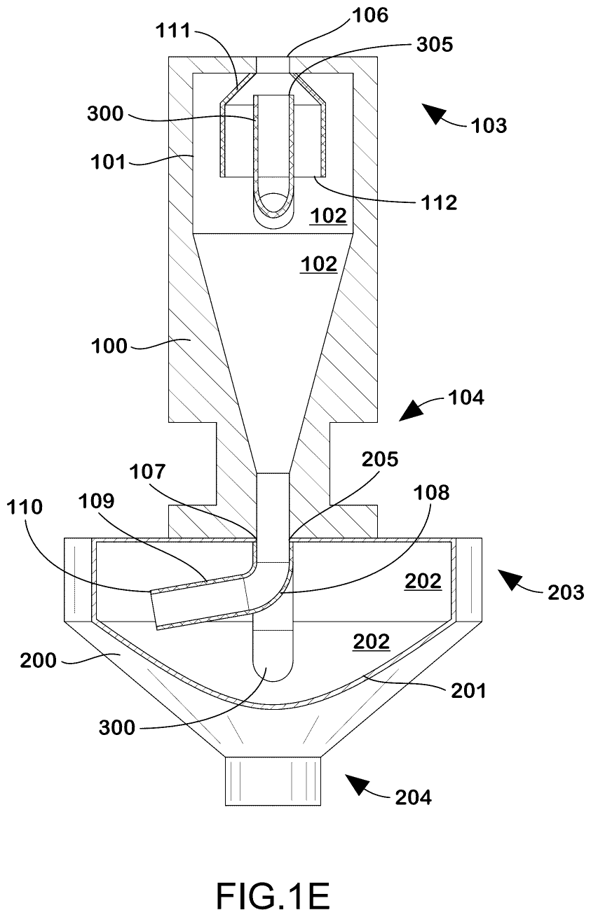

FIG. 1A through FIG. 1E depict a first illustrated embodiment of the separation system where the bypass conduit (300) leads into the primary separator (100). The process stream (401) is conveyed through the process stream conduit (113) and enters the primary enclosure (101) within the primary separator through the primary inlet (105). As shown in FIG. 1D and FIG. 1E, the primary enclosure is bounded by an upper end (103), a lower end (104), and a lateral wall (102). The filtered outlet (106) is shown disposed through the upper end of the primary enclosure. An isolation shroud (111) is shown around the filtered outlet. The isolation shroud has a bottom opening (112) which is open to the primary enclosure. The filtered stream (402) is conveyed upwards through the isolation shroud before exiting the primary enclosure through the filtered outlet.

The primary sand stream (404) passes from the primary separator (100) to the secondary separator (200). The primary outlet (107) is shown disposed through the lower end (104) of the primary enclosure (101). The secondary separator is bounded by an upper end (203) a lower end (204) and a lateral wall (202). The secondary enclosure (201) has a secondary inlet (205) disposed through the upper end (203) of the secondary enclosure. The first illustrated embodiment has a primary sand conduit (108) downstream of the secondary inlet. The primary outlet segment (109) and primary sand conduit outlet (110) are also identified in FIG. 1D and FIG. 1E. In this embodiment, the primary outlet and the secondary inlet are adjacent to each other, but other embodiments where they are not adjacent are contemplated. The disposal stream (405) exits disposal port (206) through the bottom end of the secondary enclosure.

The bypass inlet (301) of the bypass conduit (300) is disposed within the secondary separator. The bypass outlet (302) is shown disposed within the primary separator. In this embodiment, the bypass outlet passes through the bottom opening (112) of the isolation shroud and is disposed within the isolation shroud. The bypass stream (403) is conveyed from the secondary separator (200) to the primary separator (100) through the bypass conduit.

### Secondary Embodiment

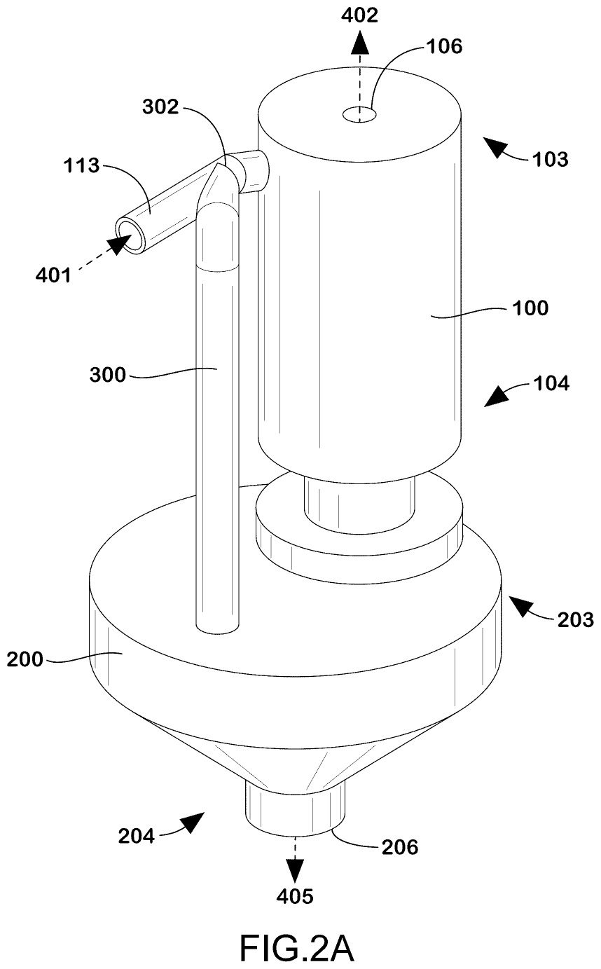

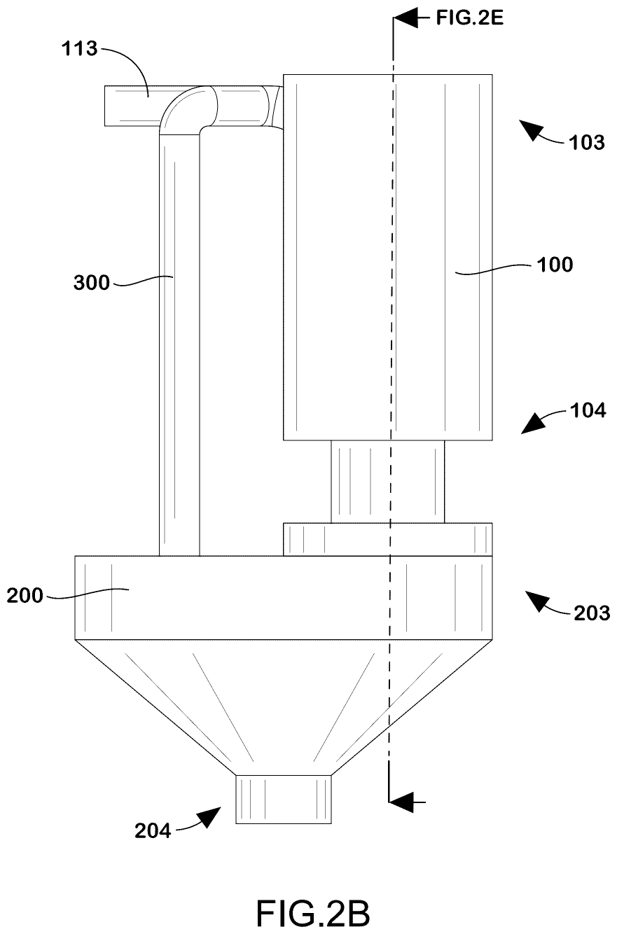

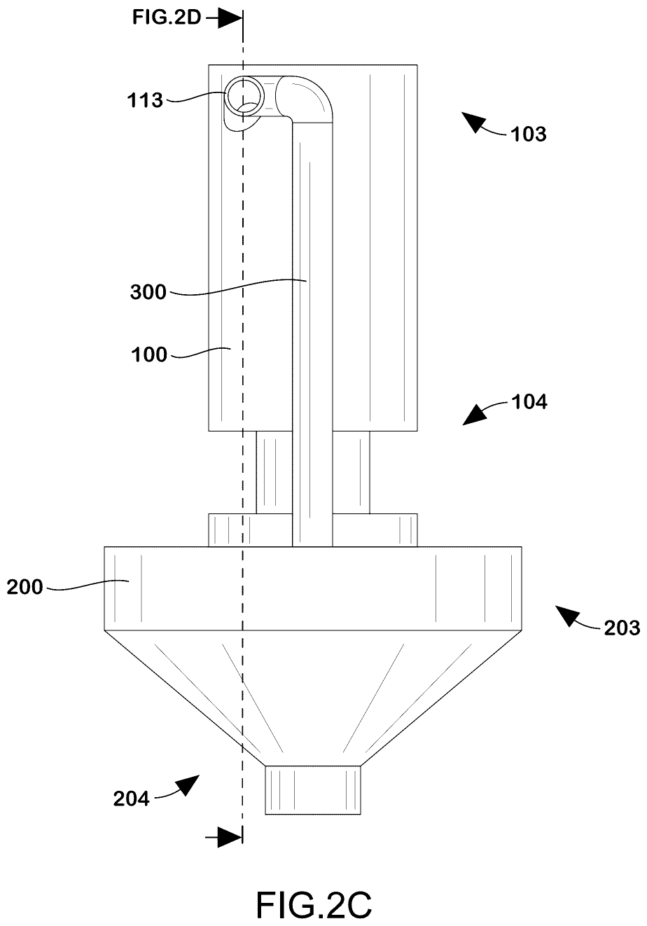

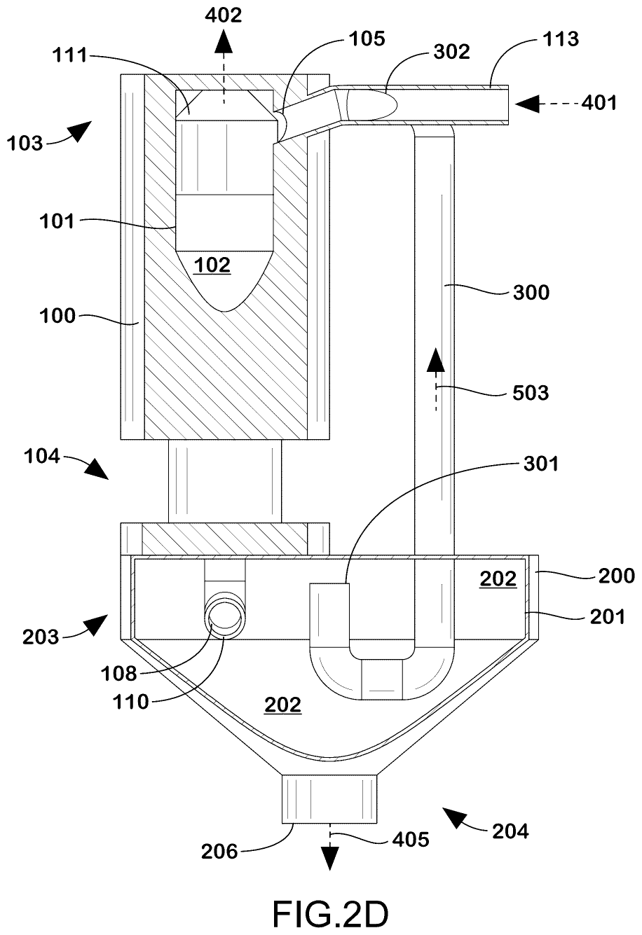

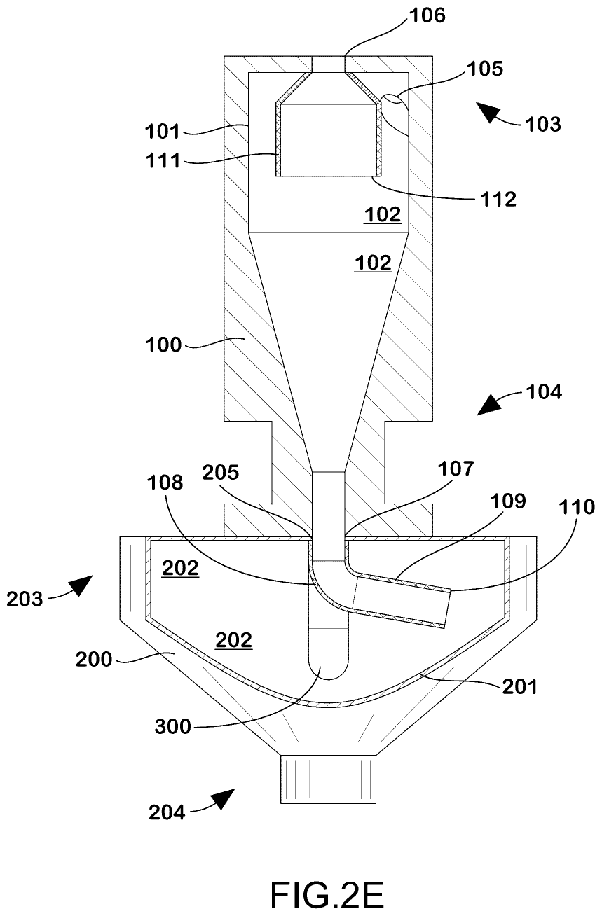

FIG. 2A-FIG. 2E depict a second illustrated embodiment of the separation system where the bypass conduit (300) merges with the process stream conduit (113) upstream of the primary separator (100). The bypass stream (403) exits the bypass outlet (302) and joins the process stream (401) before entering the primary enclosure.

### Tertiary Embodiment

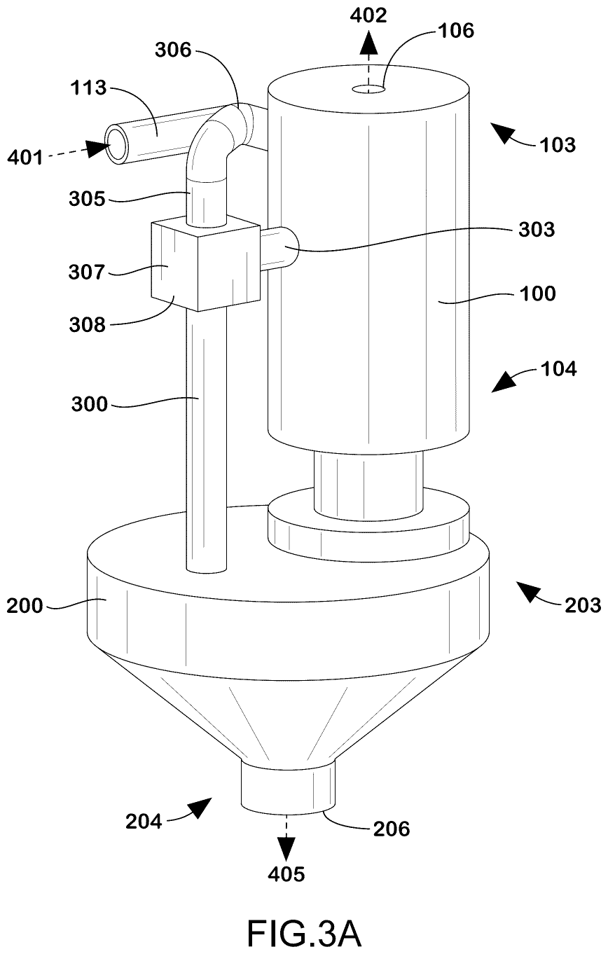

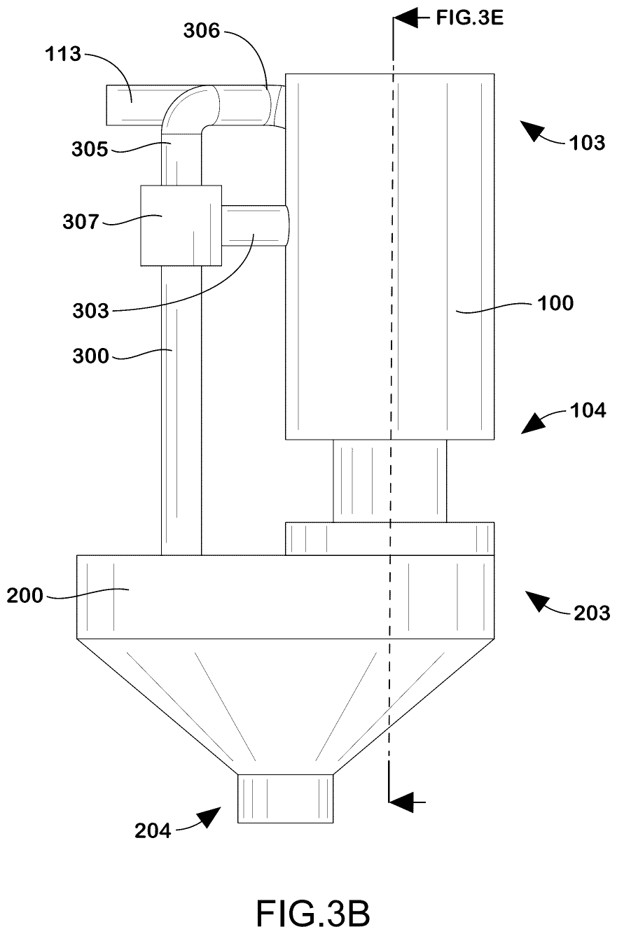

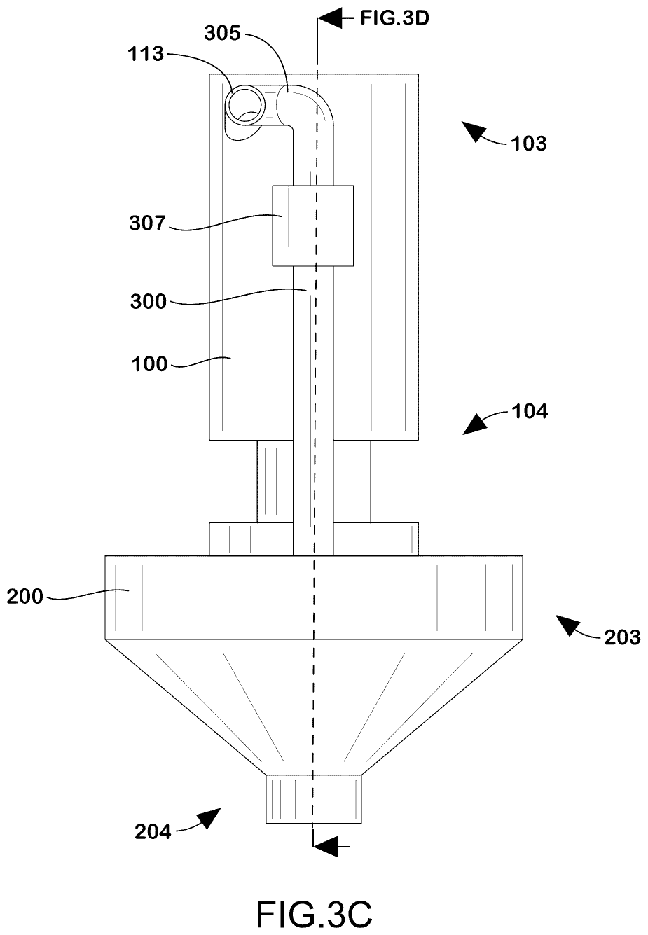

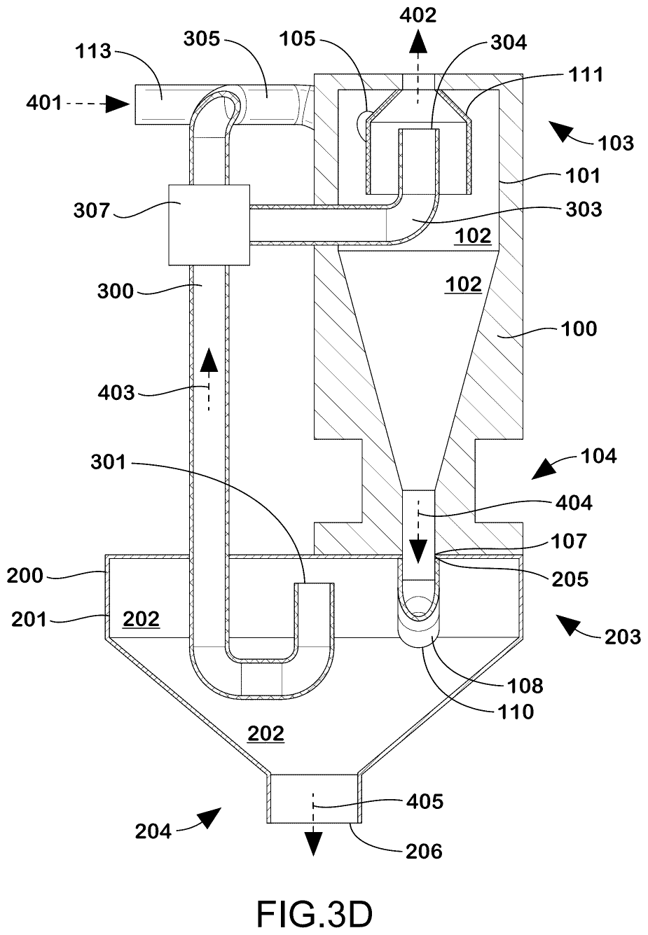

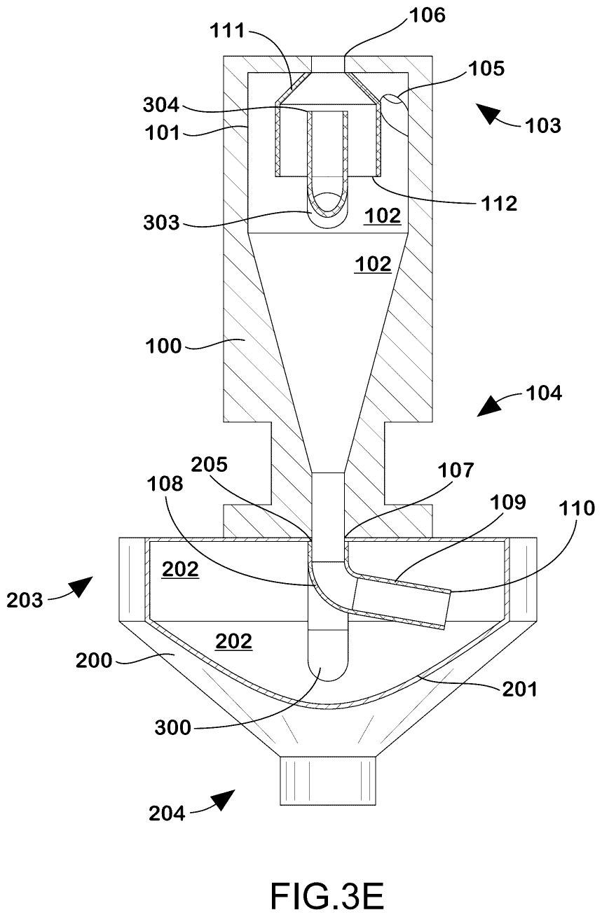

FIG. 3A-FIG. 3E depict a third illustrated embodiment of the separation system which may be thought of as a combination of the first and second illustrated embodiments. In the third illustrated embodiment, the bypass conduit passes through a splitting valve (307). The splitting valve is configured to direct the bypass stream through the interior bypass branch (303) or the exterior bypass branch (305). In this embodiment, the splitting valve is a splitting check valve (308) which prevents backflow of the bypass stream. Other embodiments where the splitting valve is not a splitting check valve are contemplated. The interior bypass branch has an interior bypass outlet (304) which is disposed within the primary enclosure (100). The exterior bypass branch has an exterior bypass outlet (306) which merges with the process stream conduit (113) upstream of the primary separator. The splitting check valve may be configured to direct the bypass stream to the interior bypass branch or the exterior bypass branch based a variety of factors including but not limited to: the composition, pressure, or flowrate of the process stream, the desired separation efficiency, the desired composition of the filtered stream (402), operational considerations, etc.

### Manufacturing

While various details, features, and combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

Feature List

| | |
|---|---|
| Primary Separator | (100) |
| Primary Enclosure | (101) |
| Lateral Wall | (102) |
| Upper End | (103) |
| Lower End | (104) |
| Primary Inlet | (105) |
| Filtered Outlet | (106) |
| Primary Outlet | (107) |
| Primary Sand Conduit | (108) |
| Primary Outlet Segment | (109) |
| Primary Sand Conduit Outlet | (110) |
| Isolation Shroud | (111) |
| Bottom Opening | (112) |
| Process Stream Conduit | (113) |
| Secondary Separator | (200) |
| Secondary Enclosure | (201) |
| Lateral Wall | (202) |
| Upper End | (203) |
| Lower End | (204) |
| Secondary Inlet | (205) |
| Disposal Port | (206) |
| Bypass Conduit | (300) |
| Bypass Inlet | (301) |
| Bypass Outlet | (302) |
| Interior Bypass Branch | (303) |
| Interior Bypass Outlet | (304) |
| Exterior Bypass Branch | (305) |
| Exterior Bypass Outlet | (306) |
| Splitting Valve | (307) |
| Splitting Check Valve | (308) |
| Process Stream | (401) |
| Filtered Stream | (402) |
| Bypass Stream | (403) |
| Primary Sand Stream | (404) |
| Disposal Stream | (405) |

What is claimed is:

1. Inventive Concept 1: Internal Bypass Branch A cyclonic separation system, the cyclonic separation system comprising a primary separator, a secondary separator, and a bypass conduit between the primary separator and secondary separator,
a. The primary separator comprises a primary enclosure, a primary inlet, a filtered outlet, and a primary outlet; the primary enclosure, where primary separation takes place, is bounded by an upper end, a lower end, and a lateral wall, the primary inlet being an opening through the primary enclosure where a process stream enters the primary enclosure, the filtered outlet being an opening through the primary enclosure towards the upper end of the primary enclosure where a filtered stream exits the primary enclosure, the filtered stream comprising mostly gas, the primary outlet being an opening through the primary enclosure where a primary sand stream exits the primary enclosure, the primary outlet being disposed towards the lower end of the primary enclosure, the primary sand stream exiting the primary outlet being conveyed into the secondary separator,
b. The secondary separator comprising a secondary enclosure, a secondary inlet, and a disposal port; the secondary enclosure is bounded by an upper end, a lower end, and a lateral wall, the secondary inlet being an opening through the secondary enclosure where the primary sand stream enters the secondary enclosure from the primary enclosure, the disposal port being an opening through the secondary enclosure where a disposal stream exits the secondary enclosure, the disposal port being disposed towards the lower end of the secondary enclosure,
c. The bypass conduit being a conduit configured to convey a bypass stream, the bypass conduit having a bypass inlet and a bypass outlet, the bypass inlet being disposed within the secondary enclosure, the bypass outlet being disposed within the primary enclosure.

2. Isolation Shroud The cyclonic separation system of claim 1, further comprising:
a. An isolation shroud, the isolation shroud having a bottom opening, the isolation shroud being attached to the upper end of the primary enclosure around the filtered outlet, the isolation shroud configured to partially isolate the bypass stream from the process stream entering the primary enclosure through the primary inlet.

3. Bypass Outlet Towards the Center of Primary Enclosure The cyclonic separation system of claim 1, wherein:
a. The bypass outlet is disposed at the horizontal center of the primary enclosure.

4. Bypass Inlet Oriented Upward The cyclonic separation system of claim 1, wherein:
a. The bypass inlet is oriented upward.

5. Bypass Inlet within Center of Secondary Separator, Oriented Vertically The cyclonic separation system of claim 1, wherein:
a. The bypass inlet is disposed within the horizontal center of the secondary separator and oriented vertically.

6. Inventive Concept 2: Exterior Bypass Branch A cyclonic separation system, the cyclonic separation system comprising a primary separator, a secondary separator, and a bypass conduit,
a. The primary separator comprises a primary enclosure, a primary inlet, a filtered outlet, and a primary outlet; the primary enclosure, where primary separation takes place, is bounded by an upper end, a lower end, and a lateral wall, the primary inlet being an opening through the primary enclosure where a process stream enters the primary enclosure, the filtered outlet being an opening through the primary enclosure towards the upper end of the primary enclosure where a filtered stream exits the primary enclosure, the filtered stream comprising mostly gas, the primary outlet being an opening through the primary enclosure where a primary sand stream exits the primary enclosure, the primary outlet being disposed towards the lower end of the primary enclosure, the primary sand stream exiting the primary outlet being conveyed into the secondary separator,
b. The secondary separator comprising a secondary enclosure, a secondary inlet, and a disposal port; the secondary enclosure is bounded by an upper end, a lower end, and a lateral wall, the secondary inlet being an opening through the secondary enclosure where the primary sand stream enters the secondary enclosure from the primary enclosure, the disposal port being an opening through the secondary enclosure where a disposal stream exits the secondary enclosure, the disposal port being disposed towards the lower end of the secondary enclosure,
c. The bypass conduit being a conduit configured to convey a bypass stream, the bypass conduit having a bypass inlet and a bypass outlet, the bypass inlet being disposed within the secondary enclosure, the bypass outlet merging with the process stream upstream of the primary inlet.

7. Bypass Outlet Angled in the Direction of Process Stream The cyclonic separation system of claim 6, wherein:
a. The bypass conduit merges with the process stream of the primary inlet at an angle.

8. Inventive Concept 3: Interior and Exterior Branches with Splitting Valve A cyclonic separation system, the cyclonic separation system comprising a primary separator, a secondary separator, a bypass conduit,
a. The primary separator comprises a primary enclosure, a primary inlet, a filtered outlet, and a primary outlet; the primary enclosure, where primary separation takes place, is bounded by an upper end, a lower end, and a lateral wall, the primary inlet being an opening through the primary enclosure where a process stream enters the primary enclosure, the filtered outlet being an opening through the primary enclosure towards the upper end of the primary enclosure where a filtered stream exits the primary enclosure, the filtered stream comprising mostly gas, the primary outlet being an opening through the primary enclosure where a primary sand stream exits the primary enclosure, the primary outlet being disposed towards the lower end of the primary enclosure, the primary sand stream exiting the primary outlet being conveyed into the secondary separator,
b. The secondary separator comprising a secondary enclosure, a secondary inlet, and a disposal port; the secondary enclosure is bounded by an upper end, a lower end, and a lateral wall, the secondary inlet being an opening through the secondary enclosure where the primary sand stream enters the secondary enclosure from the primary enclosure, the disposal port being an opening through the secondary enclosure where a disposal stream exits the secondary enclosure, the disposal port being disposed towards the lower end of the secondary enclosure,
c. The bypass conduit being a conduit configured to convey a bypass stream, the bypass conduit having a bypass inlet, a splitting valve, an interior bypass branch, and an exterior bypass branch, the bypass inlet being disposed within the secondary enclosure, the splitting valve being disposed on the bypass conduit, the splitting valve configured to convey the bypass stream from the bypass inlet through the interior bypass branch when the splitting valve is in a first position, the interior bypass branch having an interior bypass outlet disposed within the primary separator, the splitting valve configured to convey the bypass stream from the bypass inlet through the exterior bypass branch when the splitting valve is in a second position, the exterior bypass branch having an exterior bypass outlet which merges with the process stream upstream of the primary inlet.

9. Isolation Shroud The cyclonic separation system of claim 8, further comprising:
a. An isolation shroud, the isolation shroud having a bottom opening, the isolation shroud being attached to the upper end of the primary enclosure around the filtered outlet, the isolation shroud configured to partially isolate the bypass stream from the process stream entering the primary enclosure through the primary inlet.

10. Interior Bypass Outlet Towards the Center Primary Enclosure The cyclonic separation system of claim 8, wherein:
a. The bypass outlet is disposed at the horizontal center of the primary enclosure.

11. Bypass Inlet within the Center of Secondary Separator and Oriented Upward The cyclonic separation system of claim 8, wherein:
a. The bypass inlet is disposed within the horizontal center of the secondary separator and oriented vertically.

12. Exterior Bypass Outlet Angled in the Direction of Process Stream The cyclonic separation system of claim 8, further comprising:
a. A process stream conduit, the process stream conduit being disposed upstream of the primary inlet, the bypass conduit merging with the process stream conduit at an angle.

13. Conduit Between Primary and Secondary Separators has a Downward Oriented Outlet The cyclonic separation system of claim 8, further comprising:
a. A primary sand conduit, the primary sand conduit having a primary sand conduit outlet disposed at a level below the bypass inlet, wherein the primary sand conduit receives the primary sand stream from the primary outlet and conveys the primary sand stream to the secondary enclosure.

14. Outlet of the Primary Sand Conduit Between Primary and Secondary Separators is Opened Near the Lateral Wall The cyclonic separation system of claim 13, wherein:
a. The primary sand conduit outlet is disposed near the lateral wall of the secondary separator.

15. Splitting Valve First Position, Interior Bypass Branch The cyclonic separation system of claim 8, wherein:
a. The splitting valve is configured to assume the first position when the static pressure at the primary inlet is higher than the bypass inlet to prevent backflow in the bypass conduit.

16. Splitting Valve Second Position, Exterior Bypass Branch The cyclonic separation system of claim 8, wherein:
a. The splitting valve is configured to assume the second position when the static pressure at the primary inlet is lower than the static pressure at the bypass inlet.
